(19) United States
(12) Patent Application Publication
(10) Pub. No.: US 2005/0176511 A1
(43) Pub. Date: Aug. 11, 2005

(54) Fixed rotary sleeve

(76) Inventor: Chong Chi Hsiung, Tai-Ping City (TW)

Correspondence Address: CHARLES E. BAXLEY, ESQ., 90 JOHN STREET, THIRD FLOOR, NEW YORK, NY, 10038, US

(21) Appl. No.: 10/777,537

(22) Filed: Feb. 11, 2004

(51) Int. Cl. F16D 3/08

(52) U.S. Cl. 464/50

(57) ABSTRACT

The present invention relates to a fixed rotary sleeve that does not require large space for rotation, the fixed rotary sleeve is able to rotate at a fixed position, wherein on outer periphery of the drive member and the driven member are integrally formed with open grooves for insertion of drive rods, and cylinders are employed to abut against the outer peripheries of the drive member and the driven member, so as to confine the respective drive rods in the respective open grooves of the drive member and of the driven member respectively. Thereby, the fixed rotary sleeve in accordance with present invention can be produced without special machines and cramping apparatuses, thus the production cost is reduced.

### BACKGROUND OF THE INVENTION

1. Field of the Invention

The present invention relates to a fixed rotary sleeve that does not require large space for rotation, the fixed rotary sleeve is able to rotate at a fixed position, wherein on outer periphery of the drive member and the driven member are integrally formed with open grooves for insertion of drive rods, and cylinders are employed to abut against the outer peripheries of the drive member and the driven member, so as to confine the respective drive rods in the respective open grooves of the drive member and of the driven member respectively.

2. Description of the Prior Arts

A conventional handle of a sleeve that doesn't require large rotation space, namely fixed rotary sleeve, as shown in FIG. 1, wherein the fixed rotary sleeve comprises a drive member 10, a driven member 11, a connecting rod 12 and six drive rods 13. The drive member 10 and the driven member 11 are provided at their respective centers with connecting holes 101, 111, about the periphery of the connecting holes 101, 111 are respectively defined with six inserting holes 102, 112. At another end of the drive member 10 and of the driven member 11 are formed with positioning holes 103, 113 which are connected to the holes 101, 111 respectively. The connecting rod 12 is provided at both ends thereof with positioning grooves 121, 122. The connecting rod 12 has an end inserted in the connecting hole 101 of the drive member 10 and has another end inserted in the connecting hole 111 of the driven member 11, and inserting pins 14 are inserted in the positioning grooves 121, 122 via the positioning holes 103, 113. The respective drive rods 13 each has their both ends inserted in the inserting holes 102 of the drive member 10 and in the inserting holes 112 of the driven member 11 respectively. When the user rotates the drive member 10 in a desired direction, the respective drive rods 13 in the drive member 10 are forced to extend and/or retract in the inserting holes 102, 112 of the drive member 10 and the driven member 11. At the same time, the respective drive rods 13 rotate along with the rotation of the drive member 10 and synchronously move round the connecting rod 12, so as to drive the driven member 11 to rotate in the same desired direction.

This conventional fixed rotary sleeve is workable, however, it still has some effects need to be improved, such as the production cost is high cause the some special machines and cramping apparatuses should be used to produce the inserting holes of the drive member 10 and of the driven member 11.

The present invention has arisen to mitigate and/or obviate the afore-described disadvantages of the conventional fixed rotary sleeve.

### SUMMARY OF THE INVENTION

The primary object of the present invention is to provide a fixed rotary sleeve that does not require large space for rotation, the fixed rotary sleeve is able to rotate at a fixed position, wherein on outer periphery of the drive member and the driven member are integrally formed with open grooves for insertion of drive rods, and cylinders are employed to abut against the outer peripheries of the drive member and the driven member, so as to confine the respective drive rods in the respective open grooves of the drive member and of the driven member respectively. Thereby, the fixed rotary sleeve in accordance with present invention can be produced without special machines and cramping apparatuses, thus the production cost is reduced.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is an exploded view of a conventional fixed rotary sleeve;

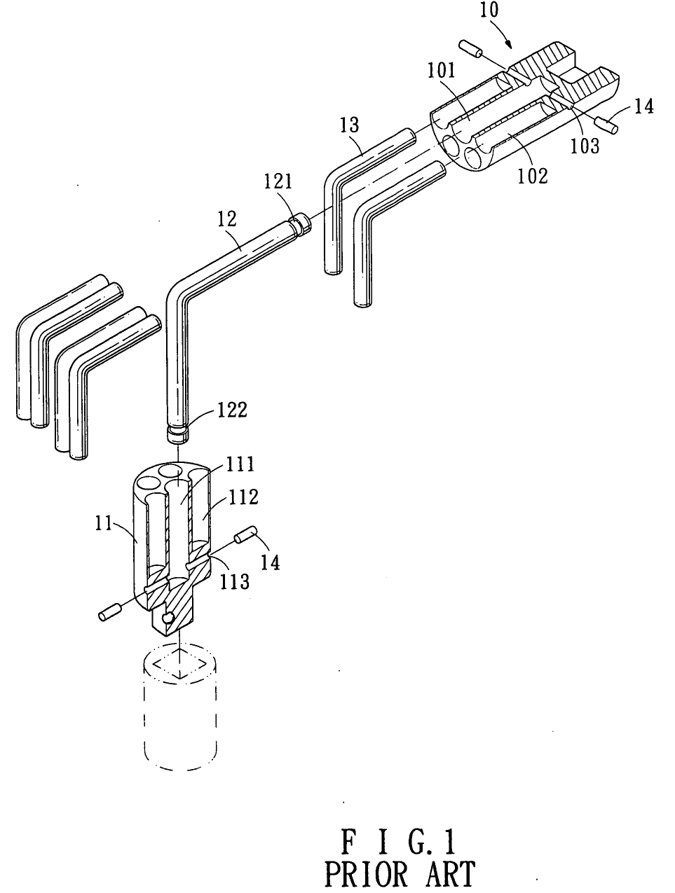

FIG. 2 is an exploded view of a fixed rotary sleeve in accordance with the present invention;

FIG. 3 is a cross sectional assembly view of the fixed rotary sleeve in accordance with the present invention;

FIG. 4 is an exploded view of a fixed rotary sleeve in accordance with a second embodiment of the present invention;

FIG. 5 is an exploded view of a fixed rotary sleeve in accordance with a third embodiment of the present invention.

### DETAILED DESCRIPTION OF THE PREFERRED EMBODIMENTS

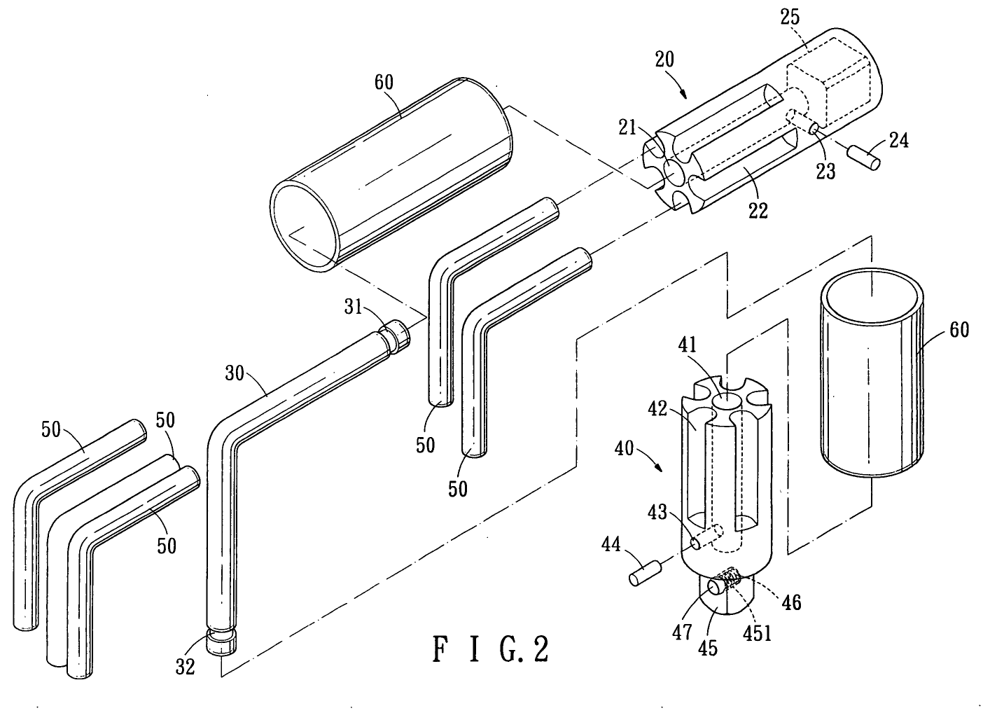

Referring to FIG. 2, a fixed rotary sleeve in accordance with an embodiment of the present invention generally comprises a drive member 20, a connecting rod 30, a driven member 40, six drive rod 50 and two cylinders 60.

The drive member 20 is formed in the shape of a cylinder, at a center of an end of which is defined with a connecting hole 21, and five open grooves 22 are integrally formed and averagely arranged on the periphery of the drive member 20. At a position on the periphery of the drive member 20 is defined a positioning hole 23 which is connected to the connecting hole 21. A positioning piece 24 is received in the positioning hole 23, and at another end of the drive member 20 is formed with a recess 25.

The connecting rod 30 is L-shaped, at a first end of which is defined with a first annular positioning groove 31 and at a second end of the connecting rod 30 is formed with a second annular positioning groove 32. The first end of the connecting rod 30 formed with the first positioning groove 31 serves to insert in the connecting hole 21 of the drive member 20, and the first positioning groove 31 of the connecting rod 30 corresponds to the positioning hole 23 of the drive member 20. An end of the positioning piece 24 inserts in the first positioning groove 31 of the connecting rod 30.

The driven member 40 is formed in the shape of a cylinder, at the center of an end of which is defined with a linking hole 41, and on the periphery of the driven member 40 are integrally formed with five open grooves 42 which are evenly distributed. At a predetermined position on the periphery of the driven member 40 is defined a locating hole 43 which is connected to the linking hole 41. A positioning piece 44 is received in the locating hole 43. At another end of the driven member 40 is defined with a protrusive connecting portion 45, and a recess 451 is formed in a periphery of the connecting portion 45 for reception of an elastic member 46 and a ball 37. The linking hole 41 of the driven member 40 is provided for insertion of the second end of the connecting rod 30 that formed with positioning groove 32. The second positioning groove 32 of the connecting rod 30 corresponds to the locating hole 43 of the driven member 40. An end of the positioning piece 44 in the locating hole 43 inserts in the second positioning groove 32 of the connecting rod 30.

The drive rods 50 are L-shaped corresponding to the connecting rod 30, both ends of the respective drive rods 50 are received in the open grooves 22 of the drive member 20 and in the open grooves 42 of the driven member 40 respectively.

The cylinders 60 serve to abut against the outer peripheral surfaces of the drive member 20 and the driven member 40, so as to confine the respective drive rods 50 in the respective open grooves 22, 42, and to confine the positioning pieces 24, 44 in the corresponding positioning holes 23, 43 respectively.

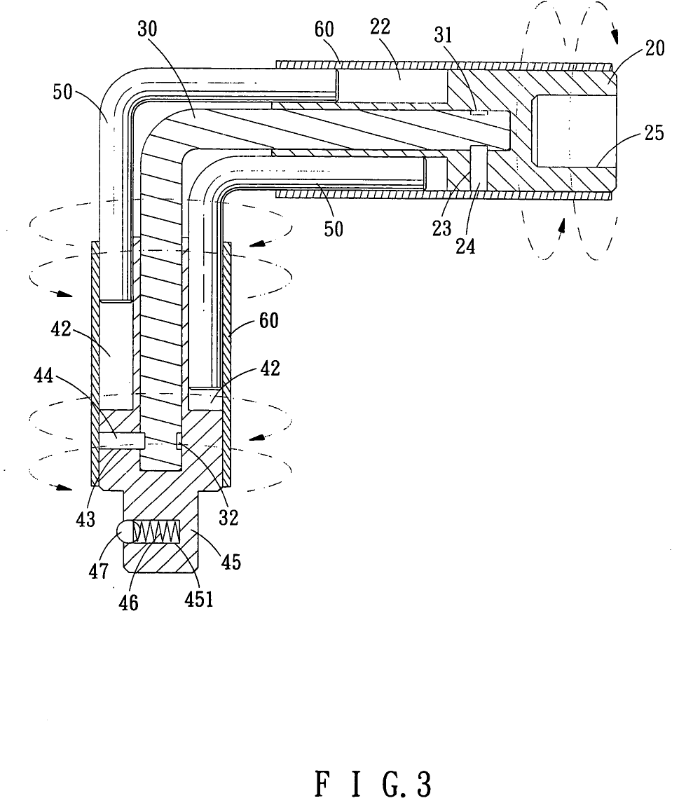

Referring to FIGS. 2 and 3, when the user rotates the drive ember 20 in a desired direction, the respective drive rods 50 received in the drive member 20 are forced to extend and/or retract in the open grooves 22 of the drive member 20 and in the open grooves 42 of the driven member 40. At the same time, the respective drive rods 50 rotate along with the rotation of the drive member 20 and synchronously move round the connecting rod 30, so as to drive the driven member 40 to rotate in the same desired direction.

The positioning open grooves 22, 42 are integrally formed on the outer peripheral surfaces of the drive member 20 and the driven member 40 for reception of the respective drive rods 50. The cylinders 60 are used to abut against the outer peripheral surfaces of the drive member 20 and the driven member 40, so as to confine the respective drive rods 50 in the respective open grooves 22, 42, and to confine the positioning pieces 24, 44 in the corresponding positioning holes 23, 43 respectively. Thereby, the fixed rotary sleeve in accordance with present invention can be easily produced without special machines and cramping apparatuses, thus the production cost is reduced.

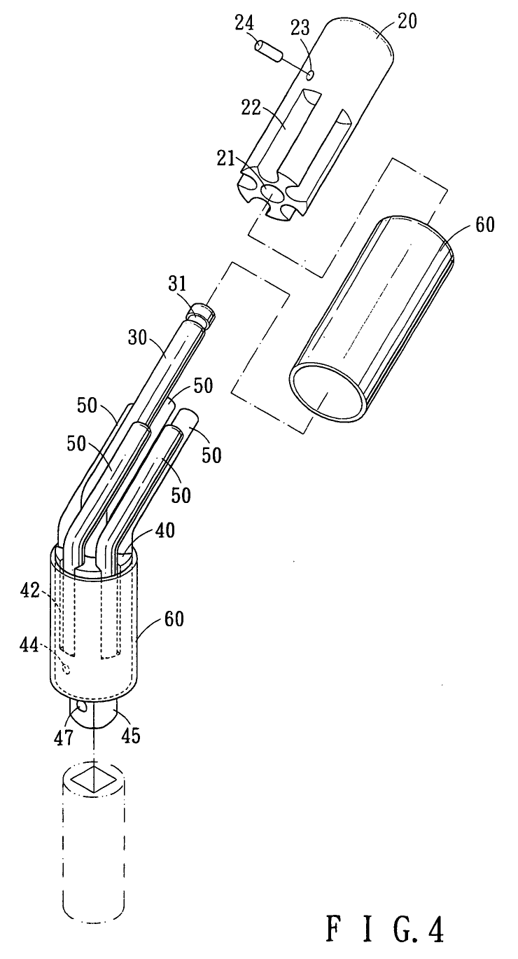

Referring to FIG. 4, which shows a fixed rotary sleeve in accordance with a second embodiment of the present invention. Wherein the connecting rod 30 and the respective drive rods 50 are folded with a specific angle. The operation theory of the fixed rotary sleeve of the second embodiment is same as that of the first embodiment, any further remarks on this matter would seem superfluous.

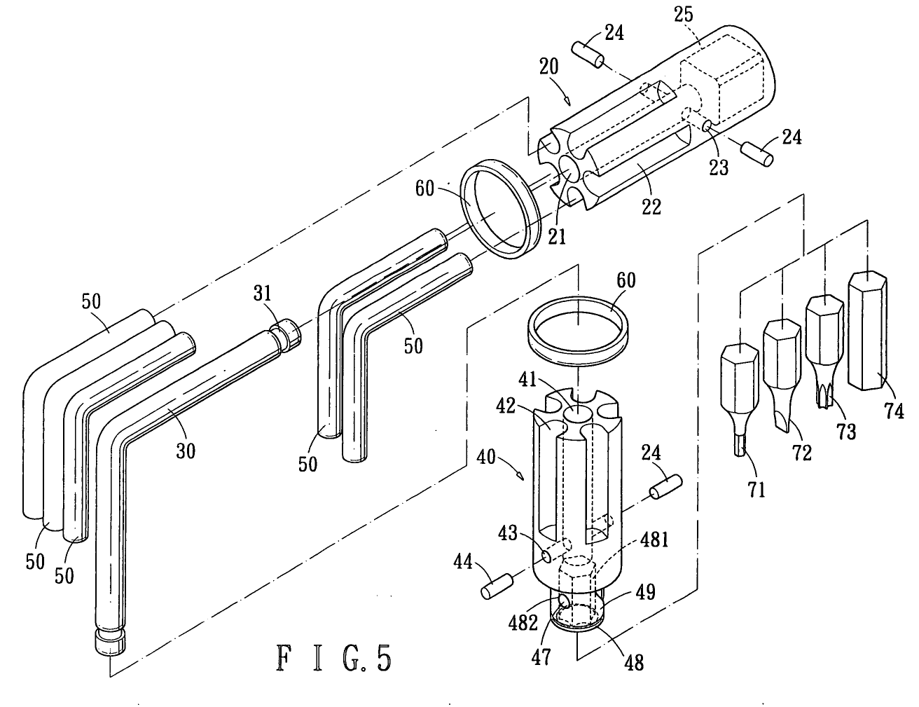

Referring to FIG. 5, which shows a fixed rotary sleeve in accordance with a third embodiment of the present invention. Wherein the cylinders 60 are made of elastic material, which are used to abut against the outer peripheral surfaces of the drive member 20 and the driven member 40, so as to confine the respective drive rods 50 in the respective open grooves 22, 42. At an end of a connecting portion 48 of the driven member 40 is defined with a hexagonal inserting groove 481, and on the periphery of the connecting portion 48 is formed with an inserting hole 482 which is connected to the inserting groove 481. A ball 47 is received in the inserting hole 482, the connecting portion 48 is pressed with a plate 49 which is used to confine the ball 17 in the inserting hole 482. The inserting groove 481 on the connecting portion 48 of the driven member 40 is provided for insertion of different tool heads 71, 72, 73 and 74 respectively. The operation theory of the fixed rotary sleeve in accordance with the third embodiment is same as that of the first embodiment, any further remarks on this matter would seem superfluous.

While we have shown and described various embodiments in accordance with the present invention, it should be clear to those skilled in the art that further embodiments may be made without departing from the scope of the present invention.

1. A fixed rotary sleeve, comprising:
a drive member formed in the shape of a cylinder, at a center of an end of which defined with a connecting hole, and plural open grooves averagely arranged on outer periphery of the drive member, on the outer periphery of the drive member defined with a positioning hole which is connected to the connecting hole, a positioning piece received in the positioning hole;
a connecting rod having a bent shape, at both ends of the connecting rod respectively formed with annular positioning groove, a first end of the connecting rod inserted in the connecting hole of the drive member, and the positioning groove at first end of the connecting rod corresponding to the positioning hole of the drive member, the positioning piece in the positioning hole having an end inserted in the positioning groove of the connecting rod;
a driven member formed in the shape of a cylinder, at center of an end of which is defined with a linking hole, and on outer periphery of the driven member evenly distributed plural open grooves, on the outer periphery of the driven member further defined a locating hole which is connected to the linking hole, a positioning member received in the locating hole, at another end of the driven member defined with a connecting portion, and a recess formed on a periphery of the connecting portion for reception of an elastic member and a ball, the linking hole of the driven member provided for insertion of the second end of the connecting rod, the positioning groove of the connecting rod corresponding to the locating hole of the driven member, an end of the positioning member inserted in the positioning groove of the connecting rod;
plural drive rods bent-shaped corresponding to the connecting rod, both ends of the respective drive rods received in the open grooves of the drive member and of the driven member respectively;
plural cylinders employed to abut against the outer peripheries of the drive member and the driven member, so as to confine the respective drive rods in the respective open grooves of the drive member and of the driven member respectively.

2. The fixed rotary sleeve as claimed in claim 1, wherein the plural cylinders are made of elastic material, which are employed to abut against the outer peripheries of the drive member and the driven member so as to confine the respective drive rods in the respective open grooves of the drive member and of the driven member respectively.

3. The fixed rotary sleeve as claimed in claim 1, wherein an inserting groove is formed on the connecting portion of the driven member for insertion of different tool heads.
